(19) United States
(12) Patent Application Publication
(10) Pub. No.: US 2018/0009129 A1
(43) Pub. Date: Jan. 11, 2018

(54) SYSTEM FOR MAKING GYPSUM BOARD USING A LIQUID GYPSUM SET ACCELERATOR

(71) Applicant: NATIONAL GYPSUM PROPERTIES, LLC, Charlotte, NC (US)

(72) Inventors: Gene Whittington, Indian Land, SC (US); Chris Fewox, Pineville, NC (US); Joseph J. Bailey, Charlotte, NC (US); John L. Phillips, Matthews, NC (US)

(21) Appl. No.: 15/206,739

(22) Filed: Jul. 11, 2016

(51) Int. Cl. B28C 5/38; B28B 1/50; B28C 7/12; C04B 28/14; C04B 111/00

(52) U.S. Cl. CPC B28C 5/386; B28C 7/126; C04B 28/14; B28B 1/50; B28C 5/388; C04B 2111/00629

(57) ABSTRACT

Systems and methods for making gypsum board using a liquid gypsum set accelerator. Stucco and water are mixed to form a gypsum slurry, such as in a pin mixer. A gypsum set accelerator is mixed with a liquid medium to form a liquid gypsum set accelerator, such as in an eductor. The liquid gypsum set accelerator is added to the gypsum slurry, which is shaped to form the gypsum board.

### BACKGROUND OF THE INVENTION

The present disclosure relates to the manufacture of gypsum board and, in particular, to systems for using liquid gypsum accelerators in the manufacture of gypsum board.

Building structures, such as walls and ceilings, are commonly constructed using gypsum board, which is often referred to as “wallboard” or “drywall.” Gypsum board typically comprises a gypsum core sandwiched between two cover sheets of facing material (e.g., paper or fiberglass). Methods for the commercial manufacture of gypsum board are well known in the art and typically involve a high speed, continuous process. The gypsum core is produced from a gypsum slurry that is prepared as a mixture of dry and wet ingredients. The dry ingredients of the gypsum slurry consist primarily of calcium sulfate hemihydrate (i.e. stucco which may include multiple gypsum phases) and may include one or more additives that are known in the art, such as fiberglass, set accelerators, functional fillers (e.g., vermiculite), crystal modifiers (e.g., boric acid) and/or binders (e.g., starch). The wet ingredients consist of water and may include paper pulp (the “paper pulp solution”) and/or one or more additional components that are known in the art, including potash, dispersants, set retarders, polymers, wax emulsion, silicone, surfactants, and thickening agents. Additional “gauging water” may be added to the gypsum slurry to achieve the desired flowability and volume of the slurry. The dry ingredients, paper pulp solution and gauging water comprise the basic chemical components of the gypsum core.

The stucco, additives and other dry ingredients are added to a mixer (e.g., a pin mixer) where they are mixed with the wet ingredients to form the gypsum slurry. The gypsum slurry is commonly output from the mixer to a canister and then discharged through an outlet chute or “boot”.

An aqueous foam is often added to the gypsum slurry, to enhance the fluidity of the slurry and control the core density and weight of the gypsum board. The foam typically comprises a mixture of foam water, a foaming agent(s) (e.g., soap) and air, and is pre-generated using various mechanical foam generation devices that are known in the art. The foam may be added to the gypsum slurry in the mixer, but is commonly introduced at the canister where additional mixing may occur.

The boot deposits and spreads the gypsum slurry onto a moving, continuous sheet of bottom (back) facing material. A moving, continuous sheet of top (face) facing material is placed on the gypsum slurry, to sandwich the slurry between the top and bottom facing materials and form the board. The board passes through a forming station which shapes the board into the desired thickness and width. Although the facing material is described as paper, other materials known in the art may be used as a facing material, such as fiberglass mat.

In some applications, the facing material may be precoated with a layer of gypsum slurry before it reaches the boot. For example, it may be desirable to strengthen the edges of a gypsum board having a foamed gypsum core, and to improve adhesion to the facing material. The surface of the facing material may be coated with a layer of relatively high density (e.g., non-foamed) gypsum slurry, which will become incorporated at the interface between the gypsum core and facing material. An apparatus for roll coating the facing material with a layer of gypsum slurry is described in U.S. Pat. No. 5,879,486 to Philips et al., which is incorporated herein by reference in its entirety. In other applications, the outer surface of the gypsum board may be roll coated with a layer of gypsum slurry—e.g., to provide the gypsum board with a smoother surface or a textured surface.

The board travels along a belt line for several minutes, during which time the stucco and water rapidly undergo a hydration reaction and the board stiffens and “sets.” In the hydration reaction, the calcium sulfate hemihydrate is hydrated to form crystals of calcium sulfate dihydrate (gypsum), according to the following equation:

CaSO₄.½H₂O+1½H₂O→CaSO₄.2H₂O+heat

The boards are then cut to a desired length and dried in a continuous kiln to evaporate excess (free) water, while the chemically bound water is retained in the newly formed gypsum crystals.

The time required to complete the setting reaction is desirably between about 5 to about 15 minutes, depending on the speed and length of the gypsum board production line. The rate of the hydration reaction varies depending on the source and method of producing the stucco, but can be controlled to some extent through the use of additives such as set retarders, set accelerators, and/or stabilizers.

Gypsum set accelerators typically comprise dried, finely ground gypsum (also referred to as “land plaster”). The land plaster particles serve as seed crystals that promote the stucco hydration reaction and cause the calcium sulfate dihydrate crystals to form at a faster rate. Land plaster used in gypsum accelerators is commonly produced in stages. The first step is drying the gypsum to remove any free moisture. The second step includes fine milling done in a ball mill or other grinding mills known in the art with different types of grinding aids. In general, the finer the land plaster particles, the more effective the accelerator.

Set accelerators are typically added to the gypsum slurry in the pin mixer with the stucco and other dry ingredients, to ensure that the accelerator is adequately dispersed throughout the gypsum slurry. When mixed with the wet ingredients, the stucco particles can agglomerate upon wetting and produce lumps, caking and/or buildup in the pin mixer and on the surfaces of other equipment. The use of a set accelerator contributes to the formation of lumps and buildup by promoting the setting reaction in the pin mixer. If the lumps are discharged from the pin mixer, they can block the flow of gypsum slurry through the equipment, may interfere with forming the gypsum board, and may cause breaks in the paper facing material which can create process upsets and downtime. As a result, the pin mixer must be cleaned periodically, which further interrupts the manufacturing process and requires substantial downtime.

Therefore, it would be desirable to provide a gypsum set accelerator that is more readily dispersed in the gypsum slurry, reduces risk of build up or agglomeration, and does not need to be introduced at the pin mixer, but may be introduced to the manufacturing process at multiple locations, including downstream of the pin mixer at the canister and/or boot to reduce the dwell time of the accelerator in the gypsum slurry while processed in the equipment.

### SUMMARY OF THE INVENTION

Systems for making a gypsum board formed from a gypsum slurry that includes stucco and water are disclosed. In one embodiment, the system comprises an apparatus for making the gypsum slurry, comprising a first mixer for mixing the stucco and water to form the gypsum slurry, a canister coupled to the mixer for receiving the gypsum slurry, and a boot coupled to the canister for discharging the gypsum slurry to form the gypsum board. The system further comprises a supply of liquid medium, a store of gypsum set accelerator, and a second mixer coupled to the supply of liquid medium and the store of gypsum set accelerator for mixing the liquid medium and gypsum set accelerator to form a liquid accelerator. The second mixer is coupled to the apparatus for making the gypsum slurry to introduce the liquid accelerator to the gypsum slurry.

In another embodiment, the system comprises an apparatus for making the gypsum slurry, comprising a first mixer for mixing the stucco and water to form the gypsum slurry, a canister coupled to the mixer for receiving the gypsum slurry, and a boot coupled to the canister for discharging the gypsum slurry to form the gypsum board. The system further comprises a supply of liquid medium, a store of gypsum set accelerator, and an eductor coupled to the supply of liquid medium and store of gypsum set accelerator. The liquid medium serves as a motive fluid in the eductor to entrain and mix the gypsum set accelerator in the liquid medium to form a liquid accelerator. The eductor is coupled to the apparatus for making the gypsum slurry to introduce the liquid accelerator to the gypsum slurry.

Methods are also disclosed for making a gypsum board, comprising the steps of: providing stucco and water; mixing the stucco and water in a first mixer to form a gypsum slurry; providing a gypsum set accelerator and a liquid medium; mixing the gypsum set accelerator and the liquid medium in a second mixer to form a liquid gypsum set accelerator; adding the liquid gypsum set accelerator to the gypsum slurry; and shaping the gypsum slurry to set and form the gypsum board.

### BRIEF DESCRIPTION OF THE DRAWINGS

The embodiments described herein and other features, advantages, and disclosures contained herein, and the manner of attaining them, will be better understood from the following description in conjunction with the accompanying drawing figures, in which like reference numerals identify like elements, and wherein:

FIG. 1 is a schematic view of a system for making a gypsum board using a liquid gypsum set accelerator.

### DETAILED DESCRIPTION OF THE INVENTION

In the following detailed description of embodiments of the present disclosure, reference is made to the accompanying drawings that form a part hereof, and in which is shown by way of illustration, and not by way of limitation, such specific embodiments. It is to be understood that other embodiments may be utilized and that changes may be made without departing from the spirit and scope of the present disclosure.

It has been found that the problems of lumps and buildup, the need for cleaning and maintenance of the equipment, and process upset and resulting downtime can be substantially reduced using a liquid gypsum set accelerator. The liquid gypsum set accelerator is readily dispersed in the gypsum slurry and does not require introduction at the pin mixer to ensure that the accelerator is adequately mixed in the gypsum slurry. As a result, the accelerator may be introduced downstream of the pin mixer—e.g., at the canister and/or boot—to reduce the formation of lumps and buildup in the mixer, and to reduce the dwell time of the accelerator in the gypsum slurry before it is discharged from the equipment to form the board. The liquid gypsum set accelerator can be produced by a continuous process that may be incorporated into a high speed, continuous process for commercial manufacture of gypsum board.

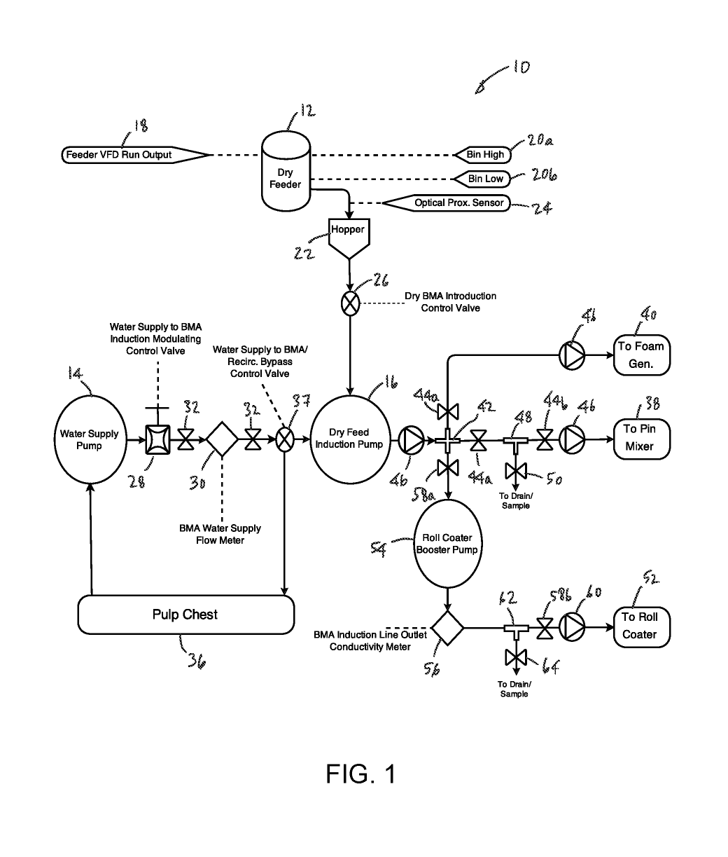

Referring now to FIG. 1, a system 10 is shown for the production of a liquid gypsum set accelerator that comprises a gypsum set accelerator in a liquid medium. The gypsum set accelerator may be any accelerator composition known in the art, including land plaster and/or ball mill accelerator (BMA), which is typically a combination of finely ground gypsum and grinding aids such as starch, sugar, water reducing agent(s), and/or other grinding aids. The liquid medium may be an aqueous liquid medium, such as water and/or an aqueous component of the gypsum slurry composition for the gypsum board. In one embodiment, the aqueous liquid medium is a paper pulp solution. However, other liquid media may be used, including non-aqueous liquid media such as an alcohol or glycerin. The gypsum set accelerator is combined with the liquid medium in a mixer to form the liquid gypsum set accelerator, which is then introduced to the manufacturing process for the gypsum board.

The liquid medium may include other process additives, as are known in the art. Where the liquid medium comprises water or other aqueous composition, the liquid medium may include a solubility inhibitor. Aqueous liquid media may produce accelerators that have reduced potency in comparison to accelerators based on non-aqueous liquid media. Where water or other aqueous composition is used, the liquid medium may include a solubility inhibitor(s). Suitable solubility inhibitors include phosphates, such as sodium trimetaphosphate (STMP). Without being limited by any particular theory, it is believed that the solubility inhibitors function to decrease the loss of active sites and reduction in crystallinity of the land plaster particles which may occur in an aqueous liquid medium.

In one embodiment, system 10 comprises a store 12 of gypsum set accelerator and a supply of liquid medium 14 that are coupled to a mixer 16. The store 12 of gypsum set accelerator may comprise a feeder, such as a volumetric feeder coupled to a variable frequency drive (VFD) for controlling the rate at which the gypsum set accelerator is introduced to the mixer 16. To facilitate continuous production, the feeder may be provided with one or more sensors 18, 20a and/or 20b for monitoring the rate of output of the feeder (18) and the amount (high, low) of gypsum set accelerator in the feeder (20a, 20b). In a further embodiment, the feeder outputs the gypsum set accelerator to a hopper 22 that is coupled to mixer 16. A sensor 24, such as an optical proximity sensor may be provided to monitor the flow of gypsum set accelerator from the feeder to the hopper 22. A valve 26 may be provided between the hopper 22 and the mixer 16, to further control the introduction of gypsum set accelerator to the mixer.

In an alternative embodiment, the gypsum set accelerator may be supplied as a suspension or slurry of accelerator particles. For example, land plaster may be produced by milling gypsum in the presence of a liquid medium to form a land plaster slurry. In another embodiment, the gypsum set accelerator may be formed by combining stucco with water or other aqueous liquid medium in a mill. As the hydration reaction proceeds, the newly formed gypsum crystals precipitate during grinding to form a slurry of fine land plaster particles.

The supply 14 of liquid medium may comprise a tank or other reservoir of the liquid medium coupled to mixer 16. Where the liquid medium includes water, supply 14 may comprise a municipal water supply. In a preferred embodiment, supply 14 includes a pump for delivering the liquid medium to mixer 16 under controlled pressure. A modulating control valve 28 and flow meter 30 may be provided to control and monitor the rate of flow of liquid medium to the mixer 16. One or more additional valves may be provided to further control the flow of the liquid medium to mixer 16, such as a shutoff valve 32 (e.g., a ball valve).

Where the liquid medium is a paper pulp solution, system 10 may comprise a pulp chest 36 for continuous mixing and production of the paper pulp solution, as is known in the art. Pulp chest 36 is coupled to supply/pump 14 for delivering the paper pulp solution to mixer 16. A bypass control valve 37 may be provided to divert the flow of paper pulp solution from mixer 16 to recirculate the paper pulp solution back through pulp chest 36—e.g., to control the consistency of the paper pulp solution.

If the gypsum set accelerator is not supplied already in liquid medium (e.g. from prior wet grinding), the liquid medium and gypsum set accelerator are combined in mixer 16 to produce the liquid gypsum set accelerator. Mixer 16 may be any mixer known in the art for mixing fine, dry materials in a liquid medium, including mixers using impellers or agitators. In a preferred embodiment, mixer 16 is configured to facilitate the continuous production of the liquid gypsum set accelerator, such as a dry powder induction device that combines the functions of a pump, eductor and mixer, as is known in the art. The eductor generally comprises a mixing chamber with an input nozzle for the liquid medium, an inlet for introduction of the gypsum set accelerator, and a converging-diverging (venturi) outlet nozzle for output of the liquid gypsum set accelerator. Hopper 22 may be configured to feed the gypsum set accelerator to the inlet of the mixing chamber. The liquid medium travels through the input nozzle of the mixing chamber and exits converging-diverging outlet nozzle, and serves as a motive fluid that creates a suction which draws the dry gypsum set accelerator into the mixing chamber. The gypsum set accelerator is entrained in the liquid medium and mixed by the shear forces at the outlet nozzle to form the liquid gypsum set accelerator.

The resulting liquid gypsum set accelerator comprises a suspension or slurry of gypsum set accelerator particles in the liquid medium, which are readily dispersed in the gypsum slurry. In contrast to conventional gypsum set accelerators, the introduction of the liquid gypsum set accelerator to the gypsum board manufacturing process is not limited to the pin mixer. The liquid gypsum set accelerator may be added at multiple points in the manufacturing process, such as at the canister or boot downstream of the mixer to minimize the dwell time of the accelerator in the gypsum slurry. The formation of lumps and buildup is substantially reduced in comparison to conventional gypsum set accelerators, which reduces the risk of process disruptions, the need for equipment maintenance, and process downtime.

In one embodiment, mixer 16 may be coupled to a mixer 38 (e.g., a pin mixer) for mixing the dry and wet ingredients of the gypsum slurry and/or coupled to a foam generator 40 for foamed gypsum slurries. The mixture of foam and liquid gypsum set accelerator may be introduced to the gypsum slurry at the canister and/or boot (not shown). For example, the output of mixer 16 may be coupled to mixer 38 and foam generator 40 by pipe, using a “tee” or “cross” valve 42. One or more shutoff valves 44a may be used to control the follow of liquid gypsum set accelerator from mixer 16 to either mixer 38 or foam generator 40. Check valves 46 may be used to prevent back flow into mixer 16 and/or from mixer 38 or foam generator 40. In a further embodiment, system 10 may be provided with a drain 48 to allow the liquid gypsum set accelerator to be sampled (e.g., for quality control) or removed from the system. Drain 48 is preferably positioned between the mixer 16 and mixer 38 and may comprise a tee pipe fitting with a shutoff valve 50. A shutoff valve 44b may be positioned between drain 48 and mixer 38 to direct the flow of liquid gypsum set accelerator to the drain.

In another embodiment, the liquid gypsum set accelerator output from mixer 16 similarly may also be coupled to a roll coater 52. A roll coater booster pump 54 may be used to control the feed of liquid gypsum set accelerator to roll coater 52. A conductivity meter 56 may be positioned to monitor any variation in the composition of the liquid gypsum set accelerator that may be caused by the accumulation of lumps or buildup. One or more shutoff valves 58a may be used to control the flow of liquid gypsum set accelerator from mixer 16 to booster pump 54. A check valve 60 may be used to prevent back flow from roll coater 52. In a further embodiment, a drain 62 may be positioned between roll coater booster pump 54 and roll coater 52, and may comprise a tee pipe fitting with a shutoff valve 64. A shutoff valve 58b may be positioned between drain 62 and roll coater 52 to direct the flow of liquid gypsum set accelerator to the drain.

The various elements of system 10 may be coupled by pipe, such as stainless steel pipe or other types of pipe known in the art. In one embodiment, the store 12, hopper 22, supply 14, pulp chest 36 and/or mixer 16 may all be coupled as described above by stainless steel ¾″ pipe. In a preferred embodiment, supply 14 is coupled to pulp chest 36 by pipe having a larger diameter (e.g., 1¼″ pipe) than the pipe coupling the supply to mixer 16 or for recirculating the paper pulp solution back to pulp chest (e.g., ¾″ pipe). In a further embodiment, the pipe undergoes a reduction in diameter from the output of mixer 16 to mixer 38 and/or to foam generator 40. For example, system 10 may comprise ¾″ stainless steel pipe at the output from mixer 16, which is reduced to ½″ or ¼″ pipe at pin mixer 38 and foam generator 40. The pipe may similarly undergo a reduction in diameter from the output of mixer 16 to roll coater 52. For example, system 10 may comprise ¾″ stainless steel pipe at the output from mixer 16, which is reduced to ¼″ pipe at roll coater 52.

The following examples are included to demonstrate preferred embodiments of the invention. It should be appreciated by those of skill in the art that the techniques disclosed in the examples which follow represent techniques discovered by the inventors to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLE

Liquid gypsum set accelerator was prepared as an aqueous suspension or slurry of conventional ball mill accelerator (BMA) using an Axi-Mix Powder Induction System comprising an Axiflow twin screw positive displacement pump configured with a hopper and eductor (Axiflow Technologies, Inc.—Lutz, Fla.). The Axiflow pump was connected to the municipal water supply, which supplied some of the water pressure for the eductor. However, fluctuations in the municipal water pressure required the use of the pump. The pump flow rate was approximately 4 gal/min at a discharge pressure of about 80 psi. The BMA was metered to the hopper at a rate of about 2 to 11 lbs/min, using a Brabender Flexwall Plus FW80 (Duisburg, Germany) calibrated volumetric screw feeder.

Gypsum board was prepared from a foamed gypsum slurry composition using conventional methods and operating conditions. The induction system was coupled to the canister for introduction of the liquid gypsum set accelerator to the gypsum slurry. A portion of the liquid gypsum set accelerator was diverted to a roll coater. A peristaltic-type pump (Netzsch—Exton, Pa.), was used to control the flow of liquid gypsum slurry to the roll coater.

The liquid gypsum set accelerator was added to the gypsum slurry comprising BMA in amounts of about 6 lbs/msf for ⅝″ and ½″ board. The amount of gauging water in the gypsum slurry composition was reduced to compensate for the addition of liquid gypsum set accelerator. Dry BMA was used as a control and introduced to the gypsum slurry at the pin mixer in similar amounts of about 4.5 lbs/msf for ⅝″ board and 6 lbs/msf for ½″ board.

During testing, the liquid gypsum set accelerator was added to the gypsum slurry and the addition of dry BMA was gradually reduced to zero. No changes in the manufacturing process were observed after introduction of the liquid gypsum set accelerator. Buildup in the pin mixer was measured using a conductivity meter. No change in amperage was observed over the period of the test using the liquid gypsum set accelerator, indicating a clean mixer.

The physical properties of the gypsum board produced using the liquid gypsum set accelerator were found to be similar to the dry BMA control. The foamed gypsum slurry was found to have similar fluidity (slump) and ¼ lb set time (Gilmore test) when prepared using either the liquid gypsum set accelerator or dry BMA control. The nail pull strength of the gypsum board was also found to be similar or only slightly reduced using the liquid gypsum set accelerator. A slight delay in the onset of stiffening was observed using the liquid gypsum set accelerator (41 sec) compared to the dry BMA control (29 sec). A slight reduction in the gypsum board weight and crystal structure was also observed with the liquid gypsum set accelerator. These small variations between the liquid gypsum set accelerator and the dry BMA control may reflect variation in activity of BMA from different sources, rather than differences in the effectiveness of the liquid gypsum set accelerator compared to the control. Any reduction in nail pull strength may reflect the reduction in board weight found in some tests using the liquid gypsum set accelerator.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

We claim:

1. A system for making a gypsum board formed from a gypsum slurry that includes stucco and water, the system comprising:
an apparatus for making the gypsum slurry, comprising:
a first mixer for mixing the stucco and water to form the gypsum slurry;
a canister coupled to the mixer for receiving the gypsum slurry; and
a boot coupled to the canister for discharging the gypsum slurry to form the gypsum board;
a supply of liquid medium;
a store of gypsum set accelerator; and
a second mixer coupled to the supply of liquid medium and the store of gypsum set accelerator for mixing the liquid medium and gypsum set accelerator to form a liquid accelerator;
wherein second mixer is coupled to the apparatus for making the gypsum slurry to introduce the liquid accelerator to the gypsum slurry.

2. The system of claim 1, wherein the second mixer is coupled to the first mixer.

3. The system of claim 1, wherein the second mixer is coupled to the canister.

4. The system of claim 1, wherein the second mixer is coupled to the boot.

5. The system of claim 1, wherein the gypsum slurry further includes an aqueous foam, and wherein the apparatus for making the gypsum slurry further comprises a foam generator, and the second mixer is coupled to the foam generator.

6. The system of claim 1, further comprising a pump coupled to the supply of liquid medium and the second mixer.

7. A system for making a gypsum board formed from a gypsum slurry that includes stucco and water, the system comprising:
an apparatus for making the gypsum slurry, comprising:
a first mixer for mixing the stucco and water to form the gypsum slurry;
a canister coupled to the mixer for receiving the gypsum slurry; and
a boot coupled to the canister for discharging the gypsum slurry to form the gypsum board;
a supply of liquid medium;
a store of gypsum set accelerator; and
an eductor coupled to the supply of liquid medium and store of gypsum set accelerator, wherein the liquid medium serves as a motive fluid in the eductor to entrain and mix the gypsum set accelerator in the liquid medium to form a liquid accelerator;
wherein the eductor is coupled to the apparatus for making the gypsum slurry to introduce the liquid accelerator to the gypsum slurry.

8. The system of claim 7, wherein the second mixer is coupled to the first mixer.

9. The system of claim 7, wherein the second mixer is coupled to the canister.

10. The system of claim 7, wherein the second mixer is coupled to the boot.

11. The system of claim 7, wherein the gypsum slurry further includes an aqueous foam, and wherein the apparatus for making the gypsum slurry further comprises a foam generator, and the second mixer is coupled to the foam generator.

12. The system of claim 7, wherein the store of gypsum set accelerator comprises a volumetric feeder coupled to the eductor.

13. The system of claim 7, further comprising a pump coupled to the supply of liquid medium and the eductor.

14. The system of claim 7, wherein the liquid medium is water.

15. The system of claim 7 wherein the liquid medium is non-aqueous.

16. The system of claim 7, wherein the liquid medium is an aqueous liquid medium that includes a solubility inhibitor.

17. The system of claim 7, wherein the liquid medium is a pulp paper solution.

18. The system of claim 7, wherein the gypsum set accelerator is land plaster.

19. A method of making a gypsum board, comprising the steps of:
providing stucco and water;
mixing the stucco and water in a first mixer to form a gypsum slurry;
providing a gypsum set accelerator and a liquid medium;
mixing the gypsum set accelerator and the liquid medium in a second mixer to form a liquid gypsum set accelerator;
adding the liquid gypsum set accelerator to the gypsum slurry; and
shaping the gypsum slurry to set to form the gypsum board.

20. The method of claim 19, further comprising the steps of:
providing an aqueous foam;
combining the liquid gypsum set accelerator with the aqueous foam; and
adding the combined liquid gypsum set accelerator and aqueous foam to the gypsum slurry.

21. The system of claim 19, wherein the liquid medium is water.

22. The system of claim 19 wherein the liquid medium is non-aqueous.

23. The system of claim 19, wherein the liquid medium is an aqueous liquid medium that includes a solubility inhibitor.

24. The system of claim 19, wherein the liquid medium is a pulp paper solution.

25. The system of claim 19, wherein the gypsum set accelerator is land plaster.
